(19) United States
(12) Patent Application Publication
(10) Pub. No.: US 2025/0079464 A1
(43) Pub. Date: Mar. 6, 2025

(54) ORGANOSULFUR CATHODES, LITHIUM-SULFUR BATTERIES INCLUDING THE SAME, AND PROCESSES OF MANUFACTURE

(71) Applicant: GM Global Technology Operations LLC, Detroit, MI (US)

(72) Inventors: Nathaniel Hardin, Farmington Hills, MI (US); Yifan Zhao, Troy, MI (US); Robert D. Schmidt, Bloomfield Hills, MI (US); Fang Dai, Troy, MI (US)

(21) Appl. No.: 18/460,788

(22) Filed: Sep. 5, 2023

(51) Int. Cl. H01M 4/60; C08F 136/06; H01M 4/137; H01M 4/62; H01M 10/0525

(52) U.S. Cl. CPC H01M 4/604; C08F 136/06; H01M 4/137; H01M 4/622; H01M 4/625; H01M 10/0525; H01M 2004/021; H01M 2004/028

(57) ABSTRACT

Organosulfur cathodes having low porosity and reduced surface area for lithium-sulfur batteries generally include sulfurized poly(1,2-butadiene), wherein the sulfurized poly (1, 2-butadiene) is a reaction product of a poly (1, 2-butadiene) monomer and a cyclic octaatomic sulfur; conductive carbon; and a binder. Optionally, the reaction product that further includes co-monomers including an alkene functionality. The co-monomers can include one or more sulfide groups selected from the group consisting of sulfide, disulfide, and polysulfide.

### INTRODUCTION

The subject disclosure generally relates to lithium-sulfur batteries, and more particularly, to organosulfur cathodes, lithium-sulfur batteries including the same, and processes for fabrication thereof, wherein the organosulfur cathodes having low porosity and decreased surface area are formed by reacting poly (1, 2-butadiene) with sulfur.

Lithium-sulfur batteries are known to have a high theoretical specific energy of about 2600 Wh/kg. Specific energy is generally defined as a ratio of the energy output of a cell or battery to its weight. The term specific energy is equivalent to the term gravimetric energy density. Such batteries can be used in commercial applications, such as portable notebooks and computers, digital and cellular phones, personal digital assistants, and the like, as well as in higher energy applications, such as hybrid and electric cars, and military or defense applications.

Lithium sulfur batteries generally include a lithium anode, an electrolyte, a porous separator, and a sulfur cathode. Discharge of a lithium sulfur battery generally includes converting sulfur to lithium polysulfide (Li₂Sₙ), where the order of n varies from 8 to 2, followed by reducing the polysulfides to solid lithium disulfide (Li₂S₂), and finally to lithium sulfide (Li₂S). The soluble polysulfide (Li₂Sₙ, 3<n<8) in the electrolyte may be deposited either on the anode or on the cathode as Li₂S. When Li₂S is deposited on the cathode, it clogs the structural pores during multiple charge/discharge cycles. In addition, there is also volume change due to the differences in the molar volumes of S and Li₂S, affecting the cathode morphology. This leads to a decrease in capacity with increasing cycle life. During charging, the Li₂S from the cathode side is oxidized to higher polysulfides (e.g., oxidized to S₈), which can migrate and are reduced to lower polysulfides by reacting on the anode. Thus, the soluble polysulfides can shuttle between cathode and anode, causing overcharging and low Coulombic efficiency in lithium-sulfur chemistry.

Conventional sulfur cathodes are typically formed using significant amounts of a conductive carbon host material (up to 50 weight percent (wt %)), which is provided to account for the low electronic conductivity of sulfur. However, the addition of large amounts of conductive filler deprecates the cell-level specific energy. The conductive carbon host can be infused with sulfur using methods such as by melt diffusion or by casting an aqueous solution of the carbon host material, a binder, and sulfur followed by drying. However, porosity is often very high impacting energy density due to the high surface area of the active material (100-1500 m²/g), which also may require higher amounts of binder making the cathode less efficient. Because of the high surface area, large amounts of electrolyte are used to sufficiently wet all the surfaces in the cathode, which adds weight to the cell and diminishes the specific energy. Moreover, these types of sulfur cathodes intrinsically produce high amounts of polysulfides upon cycling.

Accordingly, it is desirable to mitigate the issues arising from the use of sulfur cathodes in lithium-sulfur batteries that are produced with conductive carbon host materials.

### SUMMARY

In one exemplary embodiment, an organosulfur cathode for a lithium-sulfur battery or cell includes a sulfurized poly(1,2-butadiene) in an amount ranging from about 70% to about 98% by weight. The sulfurized poly (1, 2-butadiene) is a reaction product of sulfur and a poly (1, 2-butadiene) monomer. The poly (1, 2-butadiene) rubber monomer is in an amount ranging from about 5% by weight to about 60% by weight and the sulfur is in an amount ranging from about 40% by weight to about 60% by weight of the reaction product. The sulfur can be cyclic octaatomic sulfur. The organosulfur cathode further includes conductive carbon in an amount ranging from about 1% to about 20% by weight; and binder in an amount ranging from about 0.5 to about 20% by weight, wherein the weight percents are based on a total weight of the organosulfur cathode. The binder is greater than about 0.5% by weight to less than 2% by weight. The conductive carbon comprises carbon nanotubes.

In one aspect, the organosulfur cathode has a porosity greater than about 20% to less than about 60%. In other aspects, the organosulfur cathode has a porosity less than 40%.

The reaction product can further include a co-monomer comprising an alkene functionality. The alkene functionality comprises a vinyl functionality or an allyl functionality. The co-monomer further comprises sulfur groups selected from the group consisting of sulfides, disulfides, and polysulfides. In these embodiments, the poly (1, 2-butadiene) rubber monomer is in an amount ranging from about 5% by weight to about 60% by weight, the comonomer including the alkene functionality is in an amount ranging from about 5% by weight to about 60% by weight, and the sulfur is in an amount ranging from about 40% by weight to about 60% by weight of the reaction product.

In one or more embodiments, a lithium-sulfur battery or cell includes a cathode current collector; an organosulfur cathode on the cathode current collector having a porosity in a range from about 20% to about 60%, wherein the organosulfur cathode comprises a sulfurized poly(1,2-butadiene) in an amount ranging from about 70% to about 98% by weight, wherein the sulfurized poly (1, 2-butadiene) is a reaction product of sulfur and a poly (1, 2-butadiene) monomer; an anode current collector; a lithium or silicon anode on the anode current collector; a microporous polymeric separator intermediate the organosulfur cathode and the anode; and an electrolyte material between the anode and the organosulfur cathode.

In one or more aspects, the organosulfur cathode has a porosity less than 40%.

The binder can be greater than about 0.5% by weight to less than 2% by weight.

The reaction product further comprises a co-monomer comprising an alkene functionality. The alkene functionality comprises a vinyl functionality or an allyl functionality. The co-monomer can further include sulfur groups selected from the group consisting of sulfides, disulfides, and polysulfides.

In still other embodiments, a lithium-sulfur battery or cell includes a cathode current collector externally connected to a load. The cathode current collector can include aluminum. An organosulfur cathode is provided on the cathode current collector and has a porosity within a range of about 20% to about 60%. The organosulfur cathode includes sulfurized poly(1,2-butadiene) in an amount ranging from about 70% to about 98% by weight, wherein the sulfurized poly (1, 2-butadiene) is a reaction product of a poly (1, 2-butadiene) monomer in an amount ranging from about 5% by weight to about 60% by weight and a cyclic octaatomic sulfur in an amount ranging from about 40% by weight to about 60% by weight of the reaction product. The organosulfur cathode further includes conductive carbon in an amount ranging from about 1% to about 20% by weight; and binder in an amount ranging from about 0.5 to about 20% by weight, wherein the weight percents are based on a total amount of the organosulfur cathode. An anode current collector externally connected to the load, wherein the anode current collector is made of one or more materials selected from a group consisting of copper, stainless steel, nickel, iron, titanium, tin (Sₙ), and alloys thereof. A lithium or silicon anode is provided on the anode current collector; and a porous polymeric separator intermediate the cathode and the cathode.

The reaction product can further include a co-monomer comprising an alkene functionality and one or more sulfide groups selected from the group consisting of sulfide, disulfide, and polysulfide.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically illustrates a lithium-sulfur cell in accordance with one or more embodiments of the present disclosure;

FIG. 2 pictorially illustrates a micrograph depicting the milled sulfurized poly (1, 2-butadiene) rubber in accordance with one or more embodiments of the present disclosure;

FIG. 3 pictorially illustrates a micrograph of an exemplary organosulfur cathode in accordance with one or more embodiments of the present disclosure;

FIG. 4 graphically illustrates charge-discharge cycle curves for a lithium-sulfur cell in accordance with one or more embodiments of the present disclosure;

FIG. 5 graphically illustrates charge/discharge profiles after 1 and 10 cycles for a lithium-sulfur cell having a sulfurized poly (1,2-butadiene) cathode in accordance with one or more embodiments of the present disclosure;

FIG. 6 graphically illustrates charge/discharge profiles after 1 and 10 cycles for a lithium-sulfur cell having a sulfurized poly (1,2-butadiene) cathode in accordance with one or more embodiments of the present disclosure; and

FIG. 7 graphically illustrates charge/discharge profiles after 1 and 10 cycles for a lithium-sulfur cell having a sulfurized poly (1,2-butadiene)/squalene cathode in accordance with one or more embodiments of the present disclosure.

### DETAILED DESCRIPTION

The following description is merely exemplary in nature and is not intended to limit the present disclosure, its application or uses.

In accordance with exemplary embodiments, lithium-sulfur battery or cell constructions include an organosulfur cathode formed by reacting poly (1, 2-butadiene) with sulfur at an elevated temperature to form the organosulfur cathode including a sulfurized 1, 2, butadiene active material. Optionally, the reaction can further include co-monomers including alkenes such as allyl, vinyl, and/or like functionalities, wherein the co-monomers can further include sulfide, disulfide, and/or polysulfide groups to further increase the sulfur loading. Relative to prior lithium-sulfur battery or cell constructions including sulfur cathodes formed by infusion of sulfur with relatively high amounts of a conductive carbon host material and a binder, the lithium-sulfur cells with the organosulfur cathode including the sulfurized 1, 2, butadiene active material in accordance with the present disclosure result in increased cycle stability and efficiency. The organosulfur cathodes including the sulfurized 1, 2, butadiene active material have high sulfur loading, a relatively low surface area, low porosity, and can fabricated with minimal binder. The higher sulfur loading reduces the electrolyte/sulfur ratio (E/S), which greatly improves the specific energy obtained from the lithium-sulfur battery or cell constructions including the organosulfur cathode.

Conventional techniques related to the lithium-sulfur battery or cell fabrication may or may not be described in detail herein. Moreover, the various tasks and process steps described herein can be incorporated into a more comprehensive procedure or process having additional steps or functionality not described in detail herein. In particular, various steps in the lithium-sulfur battery or cell fabrication process are well known and so, in the interest of brevity, many conventional steps will only be mentioned briefly herein or will be omitted entirely without providing the well-known process details.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the battery in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects. Additionally, the terms “upper”, “lower”, “top”, “bottom”, “left,” and “right,” and derivatives thereof shall relate to the described structures, as they are oriented in the drawing figures. The same numbers in the various figures can refer to the same structural component or part thereof.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

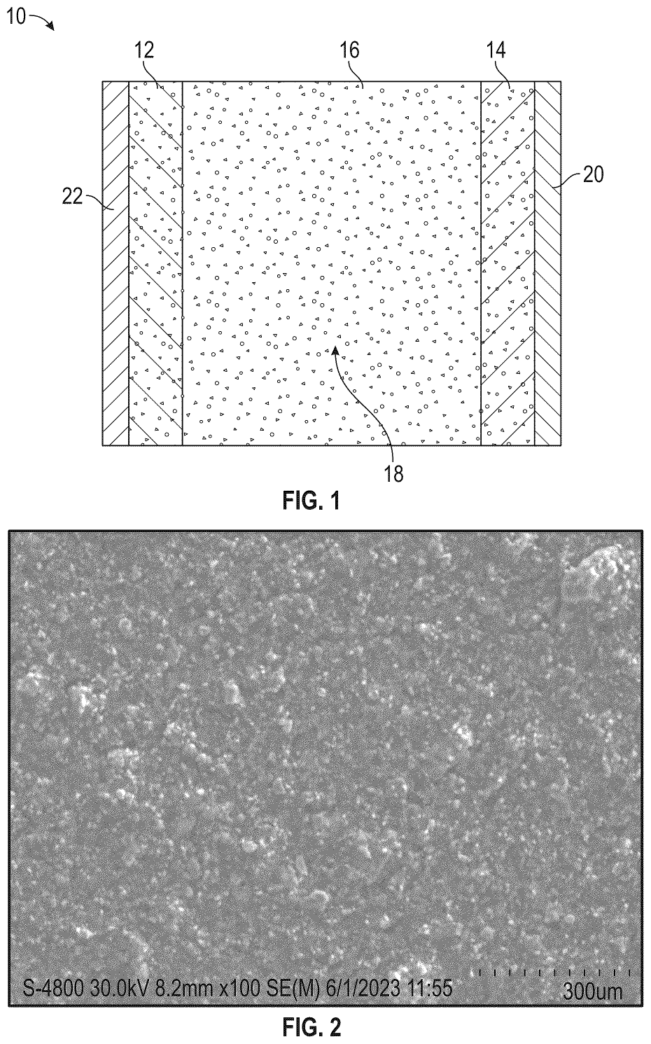

Referring now to FIG. 1, there is schematically shown a cross-sectional view of an exemplary lithium-sulfur battery or cell generally designated by reference numeral 10. The lithium-sulfur battery or cell 10 generally includes an organosulfur cathode 12 including a sulfurized 1, 2, butadiene active material, a lithium-containing or silicon-containing anode 14, a polymeric separator 16 intermediate the organosulfur cathode 12 and the anode 14, and an electrolyte material 18 therebetween. The polymeric separator 16 is electrically non-conductive and ion-pervious via the electrolyte material 18 that fills its open pores. For example, the separator 16 may be a microporous polypropylene or polyethylene sheet. The anode 14 is connected to an anode current collector 20, and the organosulfur cathode 12 is connected to a cathode current collector 22.

Terminals (not shown) extending from the respective current collectors 20, 22 can be connected in a circuit to either discharge the lithium-sulfur battery or cell 10 by connecting a load (not shown) in the circuit or charge the lithium-sulfur battery or cell 10 by connecting an external power source (not shown). The electrolyte material 18 is a lithium salt and is conducted between the organosulfur cathode 12 and the lithium-containing or silicon-containing anode 14 during cycling.

Lithium-sulfur batteries or cells 10 including the organosulfur cathodes 12 as described herein may be configured in four general ways: (1) as small, solid-body cylinders such as laptop computer batteries; (2) as large, solid-body cylinders with threaded terminals; (3) as soft, flat pouches, such as cell phone batteries with flat terminals flush to the body of the battery; and (4) as in plastic cases with large terminals in the form of aluminum and copper sheets, such as battery packs for automotive vehicles.

The lithium-sulfur batteries or cells 10 can optionally include a wide range of other components known in the art, such as gaskets, seals, terminal caps, and so on for performance-related or other practical purposes. The lithium-sulfur batteries or cells battery 10 may also be connected in an appropriately designed combination of series and parallel electrical connections with other similar batteries to produce a greater voltage output and current if the load so requires.

In one or more embodiments, the organosulfur cathode 12 is formed by reacting sulfur, such as cyclic octaatomic sulfur (S₈), with poly (1, 2-butadiene), which are relatively inexpensive and readily available, at an elevated temperature of about 180° C. to 200° C. to form, for example, a sulfurized poly (1, 2, butadiene) rubber compound as generally shown below in Scheme I.

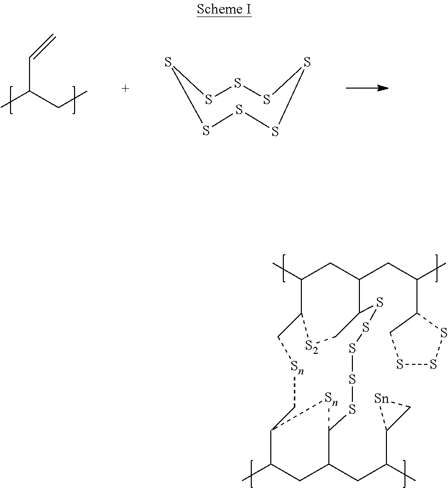

In one or more embodiments, the reaction further includes one or more co-monomers including alkenes such as allyl, vinyl, and/or like functionalities, wherein the co-monomers can further include sulfide, disulfide, and/or polysulfide groups. By way of example, squalene, divinyl benzene, diallyl disulfide or the like can be added to the reaction mixture with the poly (1, 2-butadiene) and sulfur to produce the sulfurized poly (1, 2, butadiene) rubber compound. The particular sulfurized poly (1, 2, butadiene) rubber compound is not intended to be limited to that shown above and will generally depend on the particular co-monomers added to the reaction mixture.

Formulation of the sulfurized poly (1, 2, butadiene) rubber compound can include reaction of the poly (1, 2-butadiene) in an amount ranging from about 5% to about 60% by weight of the reactants; sulfur in an amount ranging from about 40% to 95% by weight of the reactants; and optionally the comonomers in an amount ranging from about 5% to about 60% by weight of the reactants.

The organosulfur cathode 12 can be formed by mixing the sulfurized poly (1, 2, butadiene) rubber compound in an amount ranging from about 70% by weight to about 98% by weight, conductive carbon in an amount ranging from about 1% by weight to about 20% by weight; and a binder in an amount from about 0.5% by weight to about 20% by weight, wherein the weight percents are based on a total weight of the composition. In other embodiments, the sulfurized poly (1, 2, butadiene) rubber compound is in an amount ranging from about 75% by weight to about 90% by weight, the conductive carbon is in an amount ranging from about 1% by weight to about 15% by weight; and the binder is in an amount from about 0.5% by weight to about 10% by weight. In still other embodiments, the sulfurized poly (1, 2, butadiene) rubber compound is in an amount ranging from about 80% by weight to about 90% by weight, the conductive carbon is in an amount ranging from about 1% by weight to about 10% by weight, and the binder is in an amount from about 0.5% by weight to about 5% by weight. In yet other embodiments, the binder is in an amount from about 0.5% by weight to about 2% by weight.

In one or more embodiments, the sulfurized poly (1, 2, butadiene) rubber compound is milled prior to formulation of the cathode composition, wherein an average particles size can be about 5 microns (μm) to about 10 μm.

In one or more embodiments, the conductive carbon is formed from carbon nanotubes (CNT), which can include single walled carbon nanotubes (SWCNT), double walled carbon nanotubes (DWCNT), multi-walled carbon nanotubes (MWCNT) or combinations thereof. Carbon nanotubes, in general, are cylindrical carbon structures with diameters on the nanometer (nm) scale (typically a few nanometers) and lengths that can range from micrometers to millimeters. SWCNTs specifically refer to nanotubes consisting of a single layer of graphene rolled into a seamless cylinder whereas DWCNTs include concentric cylindrical two layers and multi-walled CNTs refer to more than two concentric cylindrical layers. Suitable SWCNTs, DWCNTs, and multi-walled carbon nanotubes generally have a length greater than about 1 micrometer (μm), a diameter from about 1 nm to about 6 nm and a thickness of less than 0.1 nanometers (nm), although greater or lesser diameters and thicknesses can be used. Alternatively, vapor grown carbon having the above noted dimensions can be used. In one or more embodiments, blends of the carbon nanotubes can be mixed with other types of carbon additive materials in the precursor solution (e.g., Super P™ commercially available from TIMCAL, Ketjenblack, a type of acetylene black commercially available from the Cabot Corporation, acetylene black, graphite conductive agents such as KS-6, KS-15, S-O, SEG-6, and the like, and graphene).

In practice, an aqueous slurry of the above noted components can be mixed, cast, and dried at an elevated temperature on a suitable cathode current (e.g., aluminum foil). The resulting porosity of the cast organosulfur cathode is relatively low compared to prior art sulfur cathodes, which provides higher volumetric energy density and lower surface area for higher sulfur loading and processability. As a result, less electrolyte is needed, which translates to lower weight cells or batteries. In one or more embodiments, the organosulfur cathodes of the present disclosure have a porosity ranging from about 20% to about 60%. In other embodiments, the porosity ranges from about 30% to about 55%, and in still other embodiments, the porosity range from about 40 to about 50%.

The cathode current collector 22 can be formed of aluminum or another appropriate electrically-conducive material.

The anode current collector 20 is made of one or more materials selected from a group consisting of copper, stainless steel, nickel, iron, titanium, tin (Sn), and alloys thereof.

In one or more embodiments, the anode 14 has a base electrode material such as lithium metal, which can serve as the anode active material.

The lithium metal may be in the form of, for example, a lithium metal foil or a thin lithium film that has been deposited on the anode current collector.

The lithium metal may also be in the form of a lithium alloy such as, for example, a lithium-tin alloy, a lithium aluminum alloy, a lithium magnesium alloy, a lithium zinc alloy, a lithium silicon alloy (which is used as the anode in a sulfur-silicon battery), or some combination of these.

The anode 14 may alternatively include any lithium host material that can sufficiently undergo lithium intercalation and deintercalation while functioning as the anode 14 of the lithium-sulfur battery 10.

Examples of host materials include electrically conductive carbonaceous materials such as carbon, graphite, carbon nanotubes, graphene, and petroleum coke. Mixtures of such host materials may also be used.

Graphite is widely utilized to form the anode because it is inexpensive, exhibits favorable lithium intercalation and deintercalation characteristics, is relatively non-reactive, and can store lithium in quantities that produce a relatively high energy density.

Commercial forms of graphite that may be used to fabricate the anode 14 are available from, for example, Timcal Graphite & Carbon, headquartered in Bodio, Switzerland, Lonza Group, headquartered in Basel, Switzerland, Superior Graphite, headquartered in Chicago, Ill. USA, or Hitachi Chemical Company, located in Japan.

In other embodiments, the anode 14 can be a porous silicone anode containing a lithium silicon alloy, for example, prepared with silicon nanoparticles made from high purity silicon or prepared with silicon nanowires.

The anode 14 can further include a polymer binder material in sufficient amount to structurally hold the lithium or silicon host material together. Non-limiting examples of suitable binder polymers include polyvinylidene fluoride, polyacrylonitrile, polyethylene oxide, polyethylene, polypropylene, polytetrafluoroethylene, polybutadiene, polystyrene, polyalkyl acrylates and methacrylates, ethylene-(propylene-diene-monomer)-copolymer (EPDM) rubber, copolymers of styrene and butadiene, and mixtures of such polymers. Carboxymethyl cellulose is one preferred binder for silicon-containing anodes.

The anode current collector 20 may be formed from copper or any other appropriate electrically conductive material known to skilled artisans.

The polymeric separator 16 is microporous and facilitates ion transport of lithium ions between the organosulfur cathode 12 and anode 14. Non-limiting examples of suitable separator materials include polyolefins, which may be homopolymers or a random or block copolymers, either linear or branched, including polyethylene, polypropylene, and blends and copolymers of these; polyethylene terephthalate, polyvinylidene fluoride, polyamides (nylons), polyurethanes, polycarbonates, polyesters, polyetheretherketones (PEEK), polyethersulfones (PES), polyimides (PI), polyamide-imides, polyethers, polyoxymethylene (acetal), polybutylene terephthalate, polyethylene naphthenate, polybutene, acrylonitrile-butadiene styrene copolymers (ABS), styrene copolymers, polymethyl methacrylate, polyvinyl chloride, polysiloxane polymers (such as polydimethylsiloxane (PDMS)), polybenzimidazole, polybenzoxazole, polyphenylenes, polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers, polyaramides, polyphenylene oxide, and combinations of these.

The microporous polymer separator 16 may be a woven or nonwoven single layer or a multi-layer laminate fabricated in either a dry or wet process.

In a dry process, a polymer film is stretched to make lithium-ion permeable holes between crystalline regions.

In a wet process, a material is dissolved or otherwise removed from the polymer film leaving lithium-ion permeable holes.

For example, in one example, the polymer separator may be a single layer of the polyolefin.

In another example, a single layer of one or a combination of any of the polymers from which the microporous polymer separator 16 may be formed (e.g., the polyolefin or one or more of the other polymers listed above for the separator 16). In certain embodiments a nonwoven fabric is preferred due to its random fiber orientation.

As another example, multiple discrete layers of similar or dissimilar polyolefins or other polymers for the separator 16 may be assembled in making the microporous polymer separator 16. In one example, a discrete layer of one or more of the polymers may be coated on a discrete layer of the polyolefin for the separator 16.

Further, the polyolefin (and/or other polymer) layer, and any other optional polymer layers, may further be included in the microporous polymer separator 16 as a fibrous layer to help provide the microporous polymer separator 16 with appropriate structural and porosity characteristics.

Typically, the polymeric separators 16 are about 25 micrometers in thickness.

The electrolyte material 18 can be a liquid or a solid. Liquid electrolytes generally include a lithium compound or compounds typically in the form of a lithium salt provided in an organic solvent.

The concentration of the lithium salt in the electrolyte material 18 can be in a range between 0 and 4 M, and preferably in the range between 0.05 and 1.5 M. Non-limiting examples include LiPF₆ (lithium hexafluorophosphate), LiBF₄ (lithium tetrafluoroborate), LiSbF₆, LiAsF₆ (lithium hexafluoroarsenate), LiClO₄ (lithium perchlorate), LiCF₃SO₃ (lithium trifluorosulfonate), (LiN(C₂F₅SO₂)₂) (lithium bis(perfluoroethylsulfonyl)imide), and Li(CF₃SO₂)₂N (lithium bis(trifluoro methylsulfonyl) imide or LiTFSI).

The organic solvent can be selected from acetals, ketals, sulfones, acyclic ethers, cyclic ethers, glymes, polyethers, and dioxolanes, and blends thereof.

Examples of acyclic ethers include dibutyl ether, dimethoxymethane, trimethoxymethane, dimethoxyethane (DME), diethoxyethane, 1,2-dimethoxypropane, and 1,3-dimethoxypropane.

Examples of cyclic ethers that may be used include tetrahydrofuran, tetrahydropyran, 2-methyltetrahydrofuran, 1,4-dioxane, 1,3-dioxolane, and trioxane.

Examples of polyethers that may be used include diethylene glycol dimethyl ether (diglyme), triethylene glycol dimethyl ether (triglyme, TEGDME), tetraethylene glycol dimethyl ether (tetraglyme), higher glymes, ethylene glycol divinylether, diethylene glycol divinylether, triethylene glycol divinylether, dipropylene glycol dimethyl ether, and butylene glycol ethers.

Examples of sulfones include sulfolane, 3-methyl sulfolane, and 3-sulfolene.

Solid electrolytes generally includea pseudobinary sulfide, a pseudoternary sulfide, a pseudoquaternary sulfide, a halide-based solid electrolyte, and/or a hydride-based solid electrolyte.

Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, and 0.4LiI·0.6Li₄SnS₄ and Li₁₁Si₂PSi₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3}, and LU_{0.35}[Sn_{0.27}Si_{1.08}]P_{1.65}S₁₂.

Examples, of halide-based solid electrolyte include Li₃YCl₆, Li₃InCl₆, Li₃YBr₆, LiI, Li₂CdCl₄, Li₂MgCl₄, Li₂CdI₄, Li₂ZnI₄, Li₃OCl. Examples of hydride-based solid electrolyte include LiBH₄, LiBH₄—LiX (X=Cl, Br or I), LiNH₂, Li₂NH, LiBH₄—LiNH₂, Li₃AlH₆.

In other examples, other types of solid electrolyte with low grain-boundary resistance can be used.

The lithium-sulfur battery or cell 10 with the organosulfur cathode 12 can generate a useful electric current during battery discharge by way of reversible electrochemical reactions that occur when an external circuit is closed to connect the organosulfur cathode 12 and the anode 14. The average chemical potential difference between the organosulfur cathode 12 and the anode 14 drives the electrons produced by the oxidation of lithium at the anode 14 through an external circuit towards the organosulfur cathode 12. Concomitantly, lithium ions produced at the anode 14 are carried by the electrolyte material 18 through the microporous polymer separator 16 and towards the organosulfur cathode 12. At the same time with Li⁺ ions entering the electrolyte material 18 at the anode 14, Li⁺ ions from the electrolyte material 18 recombine with electrons at an interface between the electrolyte material 18 and the organosulfur cathode 12, and the lithium concentration in the organosulfur cathode 12 increases.

The lithium-sulfur battery or cell 10 can be charged at any time by applying an external power source to the lithium-sulfur battery or cell battery 10 to reverse the electrochemical reactions that occur during battery discharge and restore electrical energy.

The connection of the external power source to the lithium-sulfur battery or cell battery 10 compels the otherwise non-spontaneous oxidation of the lithium polysulfides at the organosulfur cathode 12 to produce electrons and lithium ions.

The electrons, which flow back towards the anode 14 through an external circuit, and the lithium ions, which are carried by the electrolyte material 18 across the polymer separator 16 back towards the anode 14, reunite at the anode 14 and replenish it with lithium for consumption during the next battery discharge cycle.

Cycling of the organosulfur cathode including the sulfurized poly (1, 2-butadiene) generally proceeds as follows:

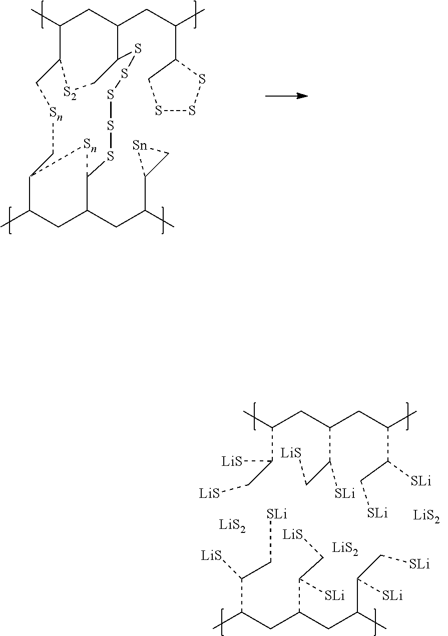

FIG. 2 pictorially illustrates a micrograph depicting the milled sulfurized poly (1, 2-butadiene) rubber produced in accordance with the reaction scheme shown in Formula I, which included 73% by weight sulfur and 27% by weight polymer. The higher sulfur loading compared to prior art sulfur infused cathodes (that typically include significant amounts of conductive carbon and binder) increases the areal capacity of the cathode (mAh/cm²), which advantageously maximizes the specific energy of the cell and represents a significant improvement over the prior art sulfur infused cathodes.

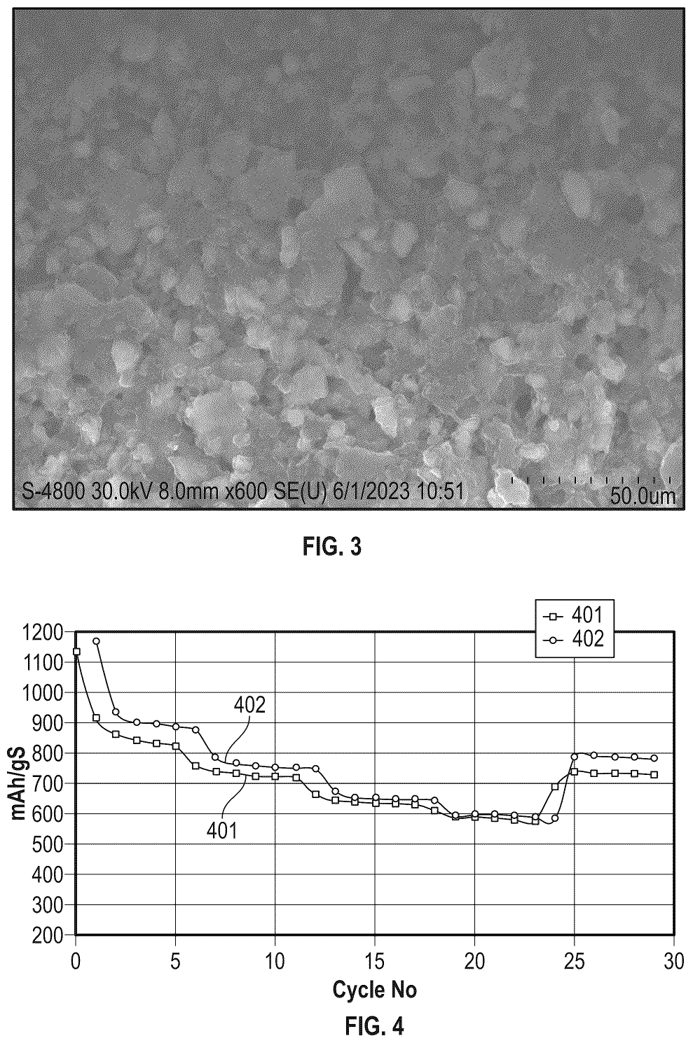

FIG. 3 pictorially illustrates a micrograph of an exemplary organosulfur cathode having a total weight of 6.38 milligrams (mg) cast on an aluminum foil substrate having a thickness of 15 μm (i.e., cathode current collector). The organosulfur cathode was cast from an aqueous slurry of 5.74 mg of the sulfurized poly (1,2-butadiene) rubber, 0.561 mg of MWCNTs, and 0.077 mg CMC binder. The cathode loading of 90:8.8:1.2 provided a stored energy potential of about 4.19 mAh.

Using the above noted organosulfur cathode and cathode current collector, a coil cell was constructed using a 1.5-millimeter (mm) space spring, a Celgard® polypropylene microporous separator, and a lithium foil having a thickness of 100 μm as the anode. The electrolyte material was mixture of 1, 3-dioxolane (DOL) and dimethoxyethane (DME) solution with 1 Molar (M) LiTFSi and 3% LiNO₃. The rate capability of the fabricated cell was 3.05 mAh/cm².

FIG. 4 provides charge/discharge curves 401, 402, respectively, generated for the lithium-sulfur cell including the organosulfur cathode including sulfurized poly (1, 2-butadiene): conductive carbon in the form of MWCNT; and CMC binder at the weight ratio of 90:8.8:1.2, respectively, which demonstrated excellent rate capability. As shown, the cell has high-rate capability and was able to generate a considerable amount of power; that is, it suffers from little polarization (voltage loss) even at high current loads.

Rate capability is determined from its C rating, which generally defines the rate of time in which it takes to charge or discharge. The C rate charge or discharge time changes in relation to the rating with 1 C being equal to 60 minutes. Higher C-rates, such as 5 C, 10 C or 20 C, represent much faster rates of charge/discharge

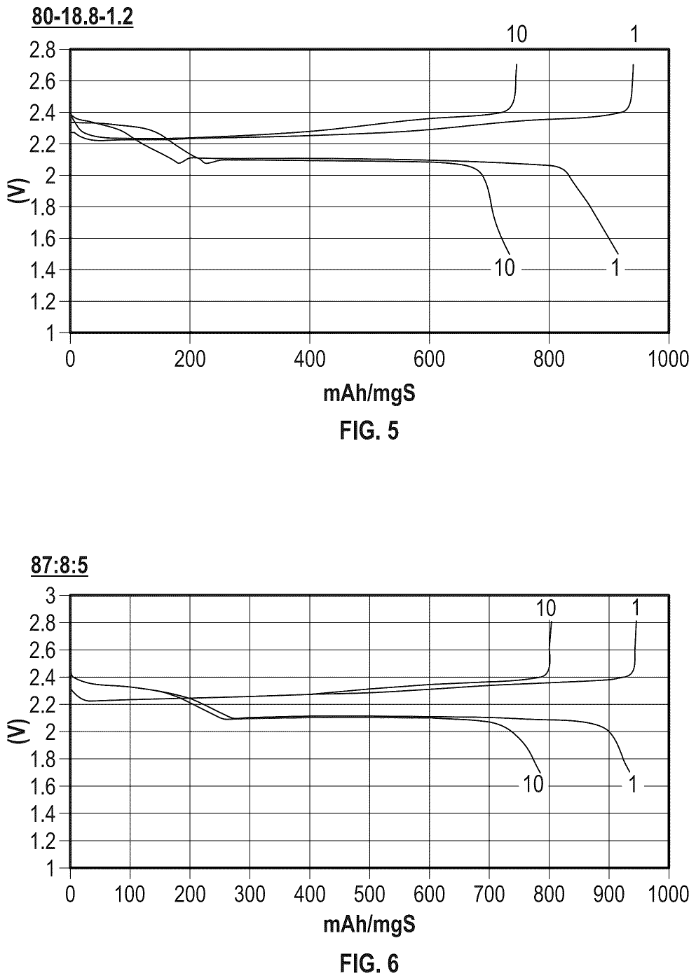

In FIG. 5, a charge/discharge profile for the lithium-sulfur cell described in FIG. 4 after cycles 1 and 10 are depicted, wherein the organosulfur cathode included sulfurized poly (1,2-butadiene) rubber, MWCNTs, and CMC binder at a loading ratio of 80:18.8:1.2, respectively. As shown, charge and discharge curves were relatively flat indicating that battery voltage remained relatively constant for the different C-rates. Specific capacities of about 1100 mAh/mgS were observed after cycle 1 and about 800 mAh/mgS after cycle 10.

In FIG. 6, a charge/discharge profile for the lithium-sulfur cell described in FIG. 4, wherein the organosulfur cathode included sulfurized poly (1,2-butadiene) rubber, MWCNTs, and CMC binder at a loading of 87:8:5, respectively. Specific capacities of about 900 m/mgS were observed after cycle 1 and about 750 mA/mgS after cycle 10.

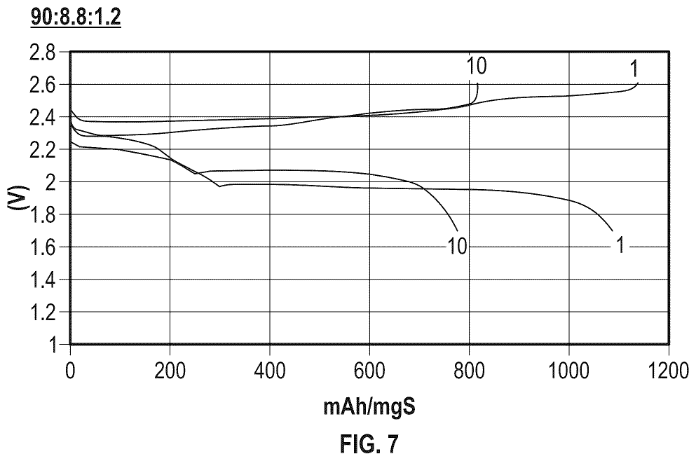

In FIG. 7, a charge/discharge profile for the lithium-sulfur cell described in FIG. 4, wherein the organosulfur cathode included sulfurized poly (1,2-butadiene) rubber with 5% by weight squalene as a co-monomer, MWCNTs, and CMC binder at a loading of 90:8.8:1.2, respectively. Specific capacities of about 1100 mAh/mgS were observed after cycle 1 and about 800 mAh/mgS after cycle 10.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An organosulfur cathode for a lithium-sulfur battery or cell, the organosulfur cathode comprising:
sulfurized poly(1,2-butadiene) in an amount ranging from about 70% to about 98% by weight, wherein the sulfurized poly (1, 2-butadiene) is a reaction product of sulfur and a poly (1, 2-butadiene) monomer;
conductive carbon in an amount ranging from about 1% to about 20% by weight; and
binder in an amount ranging from about 0.5 to about 20% by weight, wherein the weight percents are based on a total weight of the organosulfur cathode.

2. The organosulfur cathode of claim 1, wherein the organosulfur cathode has a porosity greater than about 20% to less than about 60%.

3. The organosulfur cathode of claim 1, wherein the organosulfur cathode has a porosity less than 40%.

4. The organosulfur cathode of claim 1, wherein the binder is greater than about 0.5% by weight to less than 2% by weight.

5. The organosulfur cathode of claim 1 wherein the reaction product further comprises a co-monomer comprising an alkene functionality.

6. The organosulfur cathode of claim 5, wherein the alkene functionality comprises a vinyl functionality or an allyl functionality.

7. The organosulfur cathode of claim 5, wherein the co-monomer further comprises sulfur groups selected from the group consisting of sulfides, disulfides, and polysulfides.

8. The organosulfur cathode of claim 1, wherein the conductive carbon comprises carbon nanotubes.

9. The organosulfur cathode of claim 1, wherein the sulfur is cyclic octaatomic sulfur.

10. The organosulfur cathode of claim 1, wherein the poly (1, 2-butadiene) rubber monomer is in an amount ranging from about 5% by weight to about 60% by weight and the sulfur is in an amount ranging from about 40% by weight to about 60% by weight of the reaction product.

11. The organosulfur cathode of claim 5, wherein the poly (1, 2-butadiene) rubber monomer is in an amount ranging from about 5% by weight to about 60% by weight, the co-monomer including the alkene functionality is in an amount ranging from about 5% by weight to about 60% by weight, and the sulfur is in an amount ranging from about 40% by weight to about 60% by weight of the reaction product.

12. A lithium-sulfur battery or cell construction comprising:
a cathode current collector;
an organosulfur cathode on the cathode current collector having a porosity in a range from about 20% to about 60%, wherein the organosulfur cathode comprises a sulfurized poly(1,2-butadiene) in an amount ranging from about 70% to about 98% by weight, wherein the sulfurized poly (1, 2-butadiene) is a reaction product of sulfur and a poly (1, 2-butadiene) monomer;
an anode current collector;
a lithium or silicon anode on the anode current collector;
a microporous polymeric separator intermediate the organosulfur cathode and the anode; and
an electrolyte material between the anode and the organosulfur cathode.

13. The lithium-sulfur battery or cell of claim 12, wherein the organosulfur cathode has a porosity less than 40%

14. The lithium-sulfur battery or cell of claim 12, wherein the organosulfur cathode further comprises conductive carbon in an amount ranging from about 1% to about 20% by weight; and binder in an amount greater than about 0.5% by weight to less than 2% by weight, wherein the weight percents are based on a total weight of the organosulfur cathode.

15. The lithium-sulfur battery or cell of claim 12, wherein the reaction product further comprises a co-monomer comprising an alkene functionality.

16. The lithium-sulfur battery or cell of claim 15, wherein the alkene functionality comprises a vinyl functionality or an allyl functionality.

17. The lithium-sulfur battery or cell of claim 15, wherein the co-monomer further comprises sulfur groups selected from the group consisting of sulfides, disulfides, and polysulfides.

18. The lithium-sulfur battery or cell of claim 14, wherein the conductive carbon comprises carbon nanotubes.

19. A lithium-sulfur battery or cell comprising:
a cathode current collector externally connected to a load, the cathode current collector comprising aluminum;
an organosulfur cathode on the cathode current collector having a porosity within a range of about 20% to about 60%, wherein the organosulfur cathode comprises sulfurized poly(1,2-butadiene) in an amount ranging from about 70% to about 98% by weight, wherein the sulfurized poly (1, 2-butadiene) is a reaction product of a poly (1, 2-butadiene) monomer in an amount ranging from about 5% by weight to about 60% by weight and a cyclic octaatomic sulfur in an amount ranging from about 40% by weight to about 60% by weight of the reaction product; conductive carbon in an amount ranging from about 1% to about 20% by weight; and
binder in an amount ranging from about 0.5 to about 20% by weight, wherein the weight percents are based on a total amount of the organosulfur cathode.
an anode current collector externally connected to a load, wherein the anode current collector is made of one or more materials selected from a group consisting of copper, stainless steel, nickel, iron, titanium, tin (Sₙ), and alloys thereof;
a lithium or silicon anode on the anode current collector; and
a porous polymeric separator intermediate the cathode and the cathode.

20. The lithium-sulfur battery or cell of claim 19, wherein the reaction product further comprises a co-monomer comprising an alkene functionality and one or more sulfide groups selected from the group consisting of sulfide, disulfide, and polysulfide.
